(19) United States
(12) Patent Application Publication
(10) Pub. No.: US 2025/0102982 A1
(43) Pub. Date: Mar. 27, 2025

(54) TRANSFER SYSTEM AND IMAGE FORMING SYSTEM

(71) Applicant: FUJIFILM Business Innovation Corp., Tokyo (JP)

(72) Inventor: Ko UMENAI, Kanagawa (JP)

(73) Assignee: FUJIFILM Business Innovation Corp., Tokyo (JP)

(21) Appl. No.: 18/581,397

(22) Filed: Feb. 20, 2024

(30) Foreign Application Priority Data
Sep. 26, 2023 (JP) 2023-163162

(51) Int. Cl. G03G 15/00; G03G 15/16

(52) U.S. Cl. CPC G03G 15/5054; G03G 15/161; G03G 15/1615; G03G 2215/1661

(57) ABSTRACT

A transfer system includes: a transfer belt that has an endless shape and onto which images held by a plurality of image holding bodies are sequentially transferred; a winding roll around which the transfer belt is wound and that rotates by being driven by the transfer belt revolving; a driving roll around which the transfer belt is wound, that is disposed downstream of the winding roll in a revolution direction of the transfer belt and upstream of a portion of the transfer belt onto which the image is transferred, and that applies a drive force to the transfer belt to cause the transfer belt to revolve; a transfer cylinder that is disposed on a side opposite to the winding roll with the transfer belt interposed therebetween and that transfers, to a recording medium transported, the image on the transfer belt while being rotationally driven; and a braking unit that is disposed downstream of the winding roll in the revolution direction of the transfer belt and upstream of the driving roll and that comes into contact with an inner surface of the transfer belt revolving so that a braking force is applied to the transfer belt.

### CROSS-REFERENCE TO RELATED APPLICATIONS

This application is based on and claims priority under 35 USC 119 from Japanese Patent Application No. 2023-163162 filed Sep. 26, 2023.

### BACKGROUND

### (i) Technical Field

The present invention relates to a transfer system and an image forming system.

### (ii) Related Art

An image forming apparatus described in JP2008-040289A includes a plurality of rollers that stretch an intermediate transfer belt, a drive source that rotationally drives the intermediate transfer belt, and means for applying a torque to the rollers and in a case where a recording medium enters a secondary transfer unit composed of one of stretching rollers and a facing roller that faces the one of the stretching rollers with the intermediate transfer belt interposed therebetween, the torque applied by the means for applying the torque to the rollers is corrected such that a load fluctuation at the intermediate transfer belt is suppressed.

### SUMMARY

There is a transfer system including an endless transfer belt onto which images held by a plurality of image holding bodies are sequentially transferred, a driving roll that revolves the transfer belt by applying a drive force to the transfer belt, a winding roll that rotates by being driven by the transfer belt, and a transfer cylinder that is disposed on a side opposite to the winding roll with the transfer belt interposed therebetween and that transfers, to the recording medium, the images transferred onto the transfer belt while being rotationally driven. In addition, the images held by the plurality of image holding bodies are sequentially transferred onto a portion of the transfer belt between the driving roll and the winding roll in a revolution direction of the transfer belt.

In such a transfer system, a frictional force generated between the transfer cylinder and the transfer belt fluctuates due to various factors. Due to the fluctuation in frictional force, a tensile force acting on a portion of the transfer belt between the winding roll and the driving roll in the revolution direction of the transfer belt fluctuates. In addition, due to the fluctuation in tensile force on the transfer belt, the revolution speed of the transfer belt fluctuates and image deviation of the images transferred to the transfer belt from the plurality of image holding bodies occurs.

Aspects of non-limiting embodiments of the present disclosure relate to a transfer system and an image forming system that suppress image deviation of images transferred to a transfer belt from a plurality of image holding bodies in comparison with a configuration in which a transfer belt revolves by means of a drive force of a driving roll, a transfer cylinder that transfers an image on the transfer belt to a recording medium is rotationally driven, and an inner surface of a portion of the transfer belt that is positioned downstream of a winding roll and upstream of the driving roll in a revolution direction of the transfer belt is free.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a transfer system including: a transfer belt that has an endless shape and onto which images held by a plurality of image holding bodies are sequentially transferred; a winding roll around which the transfer belt is wound and that rotates by being driven by the transfer belt revolving; a driving roll around which the transfer belt is wound, that is disposed downstream of the winding roll in a revolution direction of the transfer belt and upstream of a portion of the transfer belt onto which the image is transferred, and that applies a drive force to the transfer belt to cause the transfer belt to revolve; a transfer cylinder that is disposed on a side opposite to the winding roll with the transfer belt interposed therebetween and that transfers, to a recording medium transported, the image on the transfer belt while being rotationally driven; and a braking unit that is disposed downstream of the winding roll in the revolution direction of the transfer belt and upstream of the driving roll and that comes into contact with an inner surface of the transfer belt revolving so that a braking force is applied to the transfer belt.

### BRIEF DESCRIPTION OF THE DRAWINGS

Exemplary embodiment(s) of the present invention will be described in detail based on the following figures, wherein:

FIG. 1 is a schematic configuration view showing an image forming apparatus according to an exemplary embodiment of the present disclosure;

FIG. 2 is a schematic configuration view showing a toner image forming unit of the image forming apparatus according to the exemplary embodiment of the present disclosure;

FIG. 3 is a perspective view showing a chain gripper of the image forming apparatus according to the exemplary embodiment of the present disclosure;

FIG. 4 is a perspective view showing a secondary transfer roll or the like of a transfer device according to the exemplary embodiment of the present disclosure;

FIG. 5 is a perspective view showing a heating roll, a pressing roll, and the like of the image forming apparatus according to the exemplary embodiment of the present disclosure;

FIG. 6 is a cross-sectional view showing the heating roll, the pressing roll, and the like of the image forming apparatus according to the exemplary embodiment of the present disclosure;

FIG. 7 is a front view showing the transfer device according to the exemplary embodiment of the present disclosure;

FIGS. 8A and 8B are diagrams showing the hardware configuration and the functional configuration of a control unit provided in the transfer device according to the exemplary embodiment of the present disclosure;

FIG. 9 is a flowchart showing a step of controlling the revolution speed of a transfer belt in the transfer device according to the exemplary embodiment of the present disclosure;

FIGS. 10A and 10B are front views showing the transfer device according to the exemplary embodiment of the present disclosure in a state where an image is transferred to a sheet member and a state where no image is transferred to the sheet member; and

FIG. 11 is a front view showing a transfer device according to a comparative exemplary embodiment with respect to the exemplary embodiment of the present disclosure.

### DETAILED DESCRIPTION

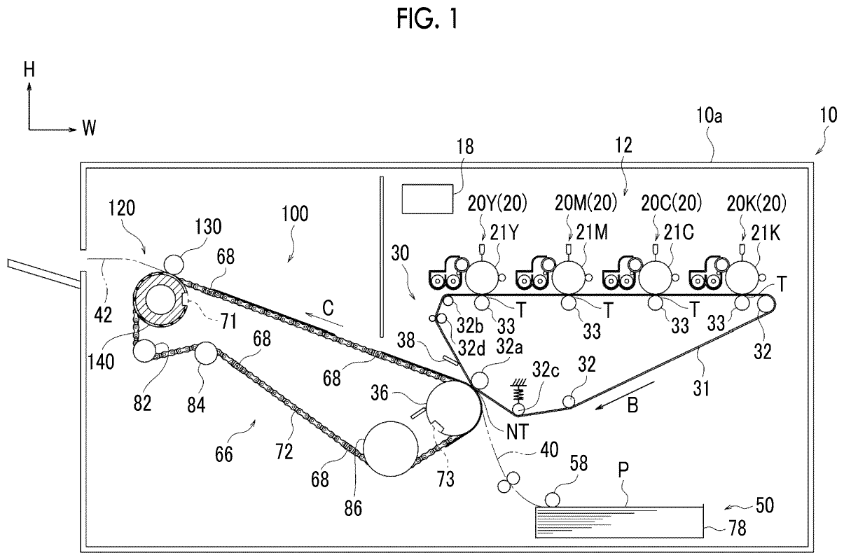

An example of a transfer device and an image forming apparatus according to an exemplary embodiment of the present invention will be described with reference to FIGS. 1 to 11. An arrow H shown in the drawings indicates an apparatus up-and-down direction (a vertical direction), an arrow W indicates an apparatus width direction (a horizontal direction), and an arrow D indicates an apparatus depth direction (a horizontal direction).

### Image Forming Apparatus 10

An image forming apparatus 10 according to the present exemplary embodiment is an electrophotographic image forming apparatus that forms a toner image on a sheet member P, which is a recording medium. As shown in FIG. 1, the image forming apparatus 10 includes an accommodation unit 50, an image forming unit 12, and a control unit 18 that controls each unit. The image forming apparatus 10 is an example of an image forming system.

### Accommodation Unit 50

The accommodation unit 50 has a function of accommodating the sheet member P. As shown in FIG. 1, the accommodation unit 50 includes a loading portion 78 onto which the sheet member P is loaded and a feeding roll 58 that feeds, to a supply path 40, the uppermost sheet member P loaded on the loading portion 78.

### Image Forming Unit 12

The image forming unit 12 has a function of forming an image on the sheet member P by means of an electrophotographic method. As shown in FIG. 1, the image forming unit 12 is disposed above the accommodation unit 50. More specifically, the image forming unit 12 includes toner image forming units 20 that form toner images, a transfer device 30 that transfers the toner images formed by the toner image forming units 20 to the sheet member P, and a fixing device 100 that fixes the toner images onto the sheet member P.

### Toner Image Forming Unit 20

As shown in FIG. 1, a plurality of the toner image forming units 20 are provided to form toner images of respective colors. In the image forming unit 12, the toner image forming units 20 for a total of four colors which are yellow (Y), magenta (M), cyan (C), and black (K) are provided. (Y), (M), (C), and (K) shown in FIG. 1 indicate constituent parts corresponding to the respective colors.

Basically, a toner image forming unit 20Y, a toner image forming unit 20M, a toner image forming unit 20C, and a toner image forming unit 20K have the same configuration as each other except for a toner to be used.

As shown in FIG. 1, the toner image forming units 20Y, 20M, 20C, and 20K are arranged along a horizontal portion of a transfer belt 31 of the transfer device 30. In the following description, the toner image forming units 20Y, 20M, 20C, and 20K will be described without alphabets letters at the ends in a case where the toner image forming units 20Y, 20M, 20C, and 20K are not to be particularly distinguished from each other.

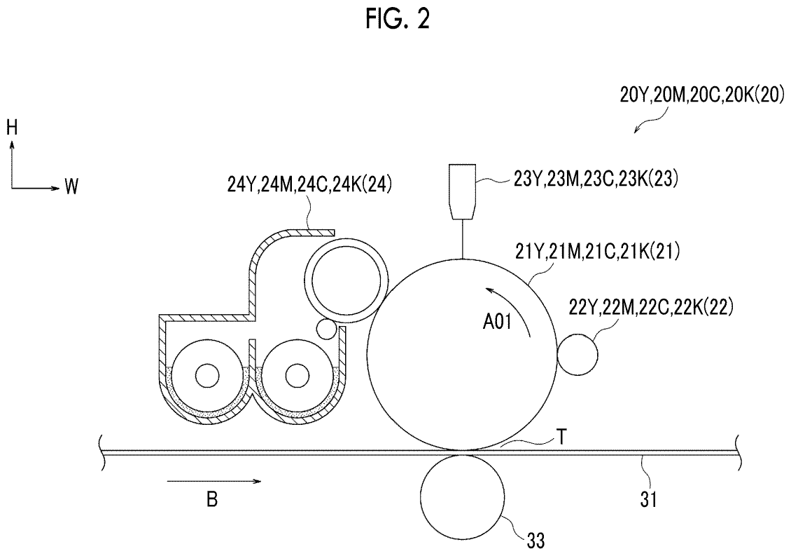

As shown in FIG. 2, the toner image forming unit 20 includes an image holding body 21 that is a photoreceptor rotating in a direction along an arrow A01 in the drawing and a charger 22 that charges the image holding body 21. Furthermore, the toner image forming unit 20 includes an exposure device 23 that forms an electrostatic latent image by causing the image holding body 21 charged by the charger 22 to be exposed to light and a development device 24 that forms a toner image by developing the electrostatic latent image by using toner.

### Transfer Device 30

The transfer device 30 has a function of primarily transferring, to an intermediate transfer body, toner images on the image holding bodies 21 for the respective colors such that the toner images are superimposed on each other and secondarily transferring, to the sheet member P, the superimposed toner images. Specifically, as shown in FIG. 1, the transfer device 30 includes the transfer belt 31 which is the intermediate transfer body, a plurality of rolls 32, primary transfer rolls 33, a transfer cylinder 36 which is a secondary transfer roll, and a scraping member 38.

The transfer belt 31 has an endless shape and is wound around the plurality of rolls 32 such that the transfer belt 31 has an inverted triangular shape. The toner image forming units 20Y, 20M, 20C, and 20K are arranged along the horizontal portion of the transfer belt 31 that is on an upper side. The transfer belt 31 revolves in a direction along an arrow B as at least one of the plurality of rolls 32 is rotationally driven.

In addition, in the following description, the roll 32 that is one of the plurality of rolls 32 and that is disposed to press an inclined portion of the transfer belt 31 that is on one side (the left side in the drawing) in the apparatus width direction will be referred to as a roll 32a and the roll 32, around which a part of the horizontal portion of the transfer belt 31 that is on the one side in the apparatus width direction is wound, will be referred to as a roll 32b. Furthermore, the roll 32 that is disposed upstream of the roll 32a in a revolution direction of the transfer belt 31 will be referred to as a roll 32c and the roll 32 that is disposed between the roll 32a and the roll 32b in the revolution direction of the transfer belt 31 will be referred to as a roll 32d.

The primary transfer rolls 33 are disposed on a side opposite to the image holding bodies 21 for the respective colors with the transfer belt 31 interposed therebetween. In addition, the primary transfer rolls 33 have a function of transferring, to the transfer belt 31, toner images formed on the image holding bodies 21 at primary transfer positions T between the image holding bodies 21 and the primary transfer rolls 33.

The transfer cylinder 36 is disposed on a side opposite to the roll 32a with the transfer belt 31 interposed therebetween. In addition, the transfer cylinder 36 has a function of transferring, to the sheet member P, the toner images transferred onto the transfer belt 31 at a secondary transfer position NT between the transfer belt 31 and the transfer cylinder 36.

In addition, the scraping member 38 is disposed between the roll 32a and the roll 32d in the revolution direction of the transfer belt 31 and the scraping member 38 has a function of scraping an adhering substance adhering to a surface of the transfer belt 31 off the transfer belt 31.

### Fixing Device 100

The fixing device 100 has a function of fixing a toner image, which is transferred to the sheet member P by the transfer device 30, onto the sheet member P.

As shown in FIG. 1, the fixing device 100 includes a chain gripper 66 and a main heating unit 120 that comes into contact with the sheet member P and that heats a toner image.

### Chain Gripper 66

As shown in FIG. 1, the chain gripper 66 includes a pair of chains 72, leading end holding portions 68 each of which holds a leading end of the sheet member P, and sprockets 71, 73, 82, 84, and 86.

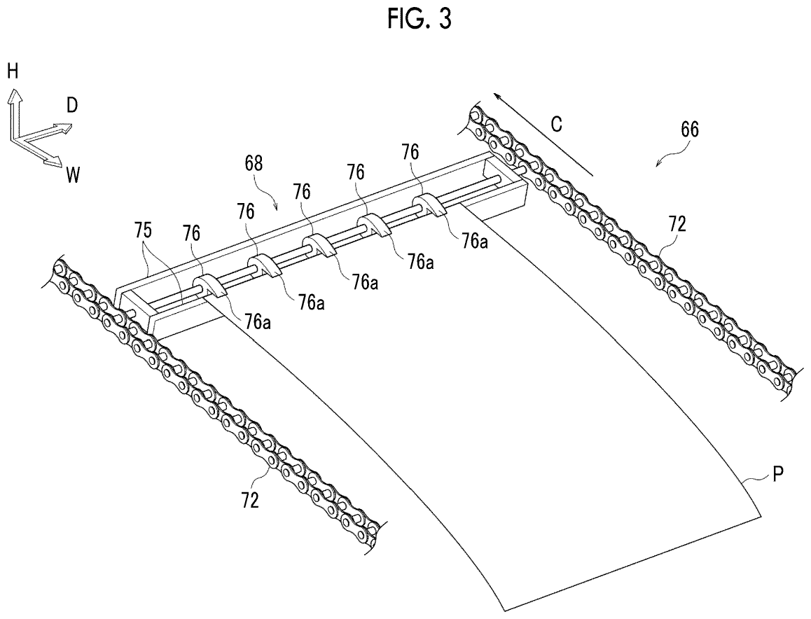

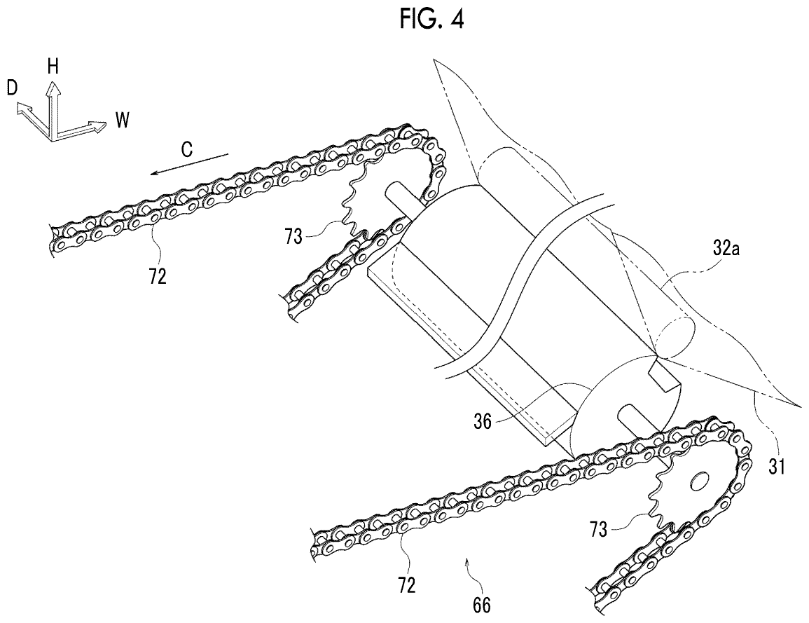

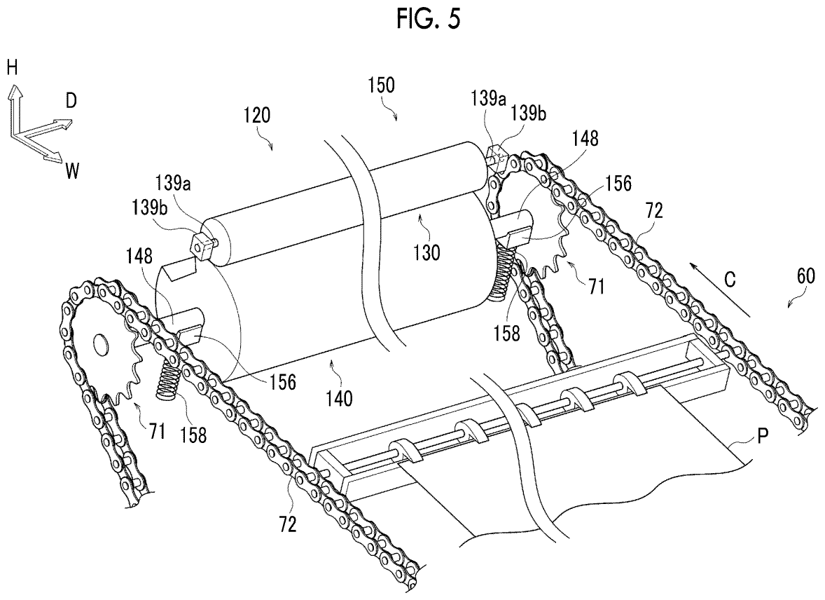

As shown in FIG. 3, the paired chains 72 are disposed to be separated from each other in the apparatus depth direction, and each of the chains 72 is formed in an endless shape. As shown in FIG. 4, the pair of chains 72 is wound around a pair of the sprockets 73 that is disposed on both end sides in an axial direction of the transfer cylinder 36 and of which an axial direction is parallel to the apparatus depth direction. In addition, the pair of chains 72 is wound around a pair of the sprockets 71 (refer to FIG. 5) that is disposed on one end side and the other end side in an axial direction of a pressing roll 140 (which will be described later) and of which an axial direction is parallel to the apparatus depth direction. Furthermore, the pair of chains 72 is wound around a pair of the sprockets 82, a pair of the sprockets 84, and a pair of the sprockets 86 that are disposed such that the sprockets are disposed at an interval in the apparatus depth direction.

In addition, as shown in FIG. 1, the sprockets 71 that are disposed on both end sides of the pressing roll 140 are disposed closer to the one side (the left side in the drawing) in the apparatus width direction than the sprockets 73 disposed on both end sides of the transfer cylinder 36 are and the sprockets 71 are disposed above the sprockets 73.

In addition, as seen in the apparatus depth direction, the pair of sprockets 82 is disposed below the sprockets 71. Furthermore, the pair of sprockets 86 is disposed below the sprockets 73 and 82, is disposed closer to the one side in the apparatus width direction than the sprockets 73 are, and is disposed closer to the other side in the apparatus width direction than the sprockets 82 are. In addition, the pair of sprockets 84 is disposed to lift, from a lower side to the upper side, portions of the chains 72 that are between the sprockets 82 and the sprockets 86.

As shown in FIG. 3, each leading end holding portion 68 includes an attachment member 75 extending in the apparatus depth direction and grippers 76 attached to the attachment member 75 and both side portions of the leading end holding portion 68 in the apparatus depth direction are attached to the pair of chains 72, respectively.

A plurality of the leading end holding portions 68 are provided and are disposed at predetermined intervals in a circumferential direction (the revolution direction) of the chains 72 (refer to FIG. 1).

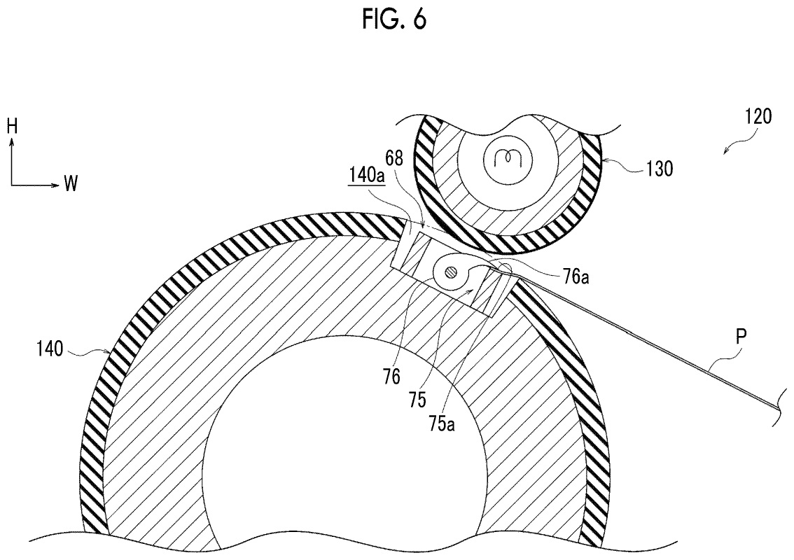

A plurality of the grippers 76 are provided and are attached to the attachment member 75 at predetermined intervals in the apparatus depth direction. Each gripper 76 has a function of holding the leading end of the sheet member P. Specifically, the grippers 76 include claws 76a. In addition, a contact portion 75a (refer to FIG. 6) with which the claws 76a come into contact is formed at the attachment member 75.

The grippers 76 are configured to hold the sheet member P with the leading end of the sheet member P being sandwiched between the claws 76a and the contact portion 75a. Note that, regarding the grippers 76, for example, the claws 76a are pressed against the contact portion 75a by a spring or the like and the claws 76a are opened or closed with respect to the contact portion 75a by the action of a cam or the like.

In this configuration, a rotational force is transmitted to the sprockets 71 and 73 out of the plurality of sprockets 71, 73, 82, 84, and 86 shown in FIG. 1 so that the pair of chains 72 revolve in a direction along an arrow C in the drawing.

Furthermore, when the leading end holding portion 68 attached to the pair of chains 72 reaches the sprockets 73, the grippers 76 of the leading end holding portion 68 hold and receive the sheet member P transported along the supply path 40 by sandwiching the leading end of the sheet member P. Then, the chains 72 revolving in the direction along the arrow C transport, toward the secondary transfer position NT, the sheet member P held by the leading end holding portion 68. Furthermore, the revolving chains 72 transport the sheet member P toward the main heating unit 120. In addition, at a position where the leading end of the sheet member P passes through the main heating unit 120, the leading end holding portion 68 releases the leading end of the sheet member P so that the chain gripper 66 feeds the sheet member P to a discharge path 42. Then, the sheet member P fed to the discharge path 42 is discharged to the outside of an apparatus body 10a.

### Main Heating Unit 120

As shown in FIG. 1, the main heating unit 120 is disposed downstream of the secondary transfer position NT in a sheet transport direction. In addition, as shown in FIG. 5, the main heating unit 120 includes a heating roll 130 that comes into contact with the sheet member P transported and that heats the sheet member P and the pressing roll 140 that presses the sheet member P toward the heating roll 130.

The heating roll 130 is disposed to come into contact with an upward-facing surface of the sheet member P transported and to extend in the apparatus depth direction with an axial direction thereof being parallel to the apparatus depth direction. In addition, shaft portions 139a extending in the apparatus depth direction are respectively formed at both end portions of the heating roll 130 in the apparatus depth direction and supporting members 139b respectively supporting the shaft portions 139a are provided.

The pressing roll 140 is disposed to come into contact with, on a side opposite to the heating roll 130 with the sheet member P transported therebetween, a downward-facing surface of the sheet member P transported and to extend in the apparatus depth direction with an axial direction thereof being parallel to the apparatus depth direction. In addition, as shown in FIG. 6, a recess portion 140a extending in the apparatus depth direction is formed at an outer peripheral surface of the pressing roll 140. In addition, in a case where the sheet member P passes through a space between the pressing roll 140 and the heating roll 130, the recess portion 140a accommodates the leading end holding portion 68 gripping the leading end of the sheet member P.

In addition, as shown in FIG. 5, a pair of shaft portions 148 is formed at both end portions of the pressing roll 140 in the apparatus depth direction. The diameter of the shaft portions 148 is smaller than the diameter of the pressing roll 140 and the shaft portions 148 extend in the axial direction.

Furthermore, the main heating unit 120 includes supporting members 156 that support the pressing roll 140 and urging members 158 that urge the pressing roll 140 to the heating roll 130 side via the supporting members 156. A pair of the supporting members 156 is provided. The pair of supporting members 156 is disposed to rotatably support the pair of shaft portions 148 of the pressing roll 140 from below, respectively.

In this configuration, a pair of the urging members 158 urges the pressing roll 140 to the heating roll 130 side so that the pressing roll 140 presses the sheet member P toward the heating roll 130. Furthermore, the pressing roll 140 is rotated by a rotational force transmitted from a drive member (not shown). In addition, the heating roll 130 rotates by being driven by the pressing roll 140 rotated. Furthermore, the heating roll 130 and the pressing roll 140 transport the sheet member P, onto which a toner image has been transferred, with the sheet member P sandwiched between the heating roll 130 and the pressing roll 140, so that the toner image is heated and fixed onto the sheet member P.

### Action of Image Forming Apparatus

In the image forming apparatus 10 shown in FIG. 1, a toner image is formed on the sheet member P as follows. First, the chargers 22 for the respective colors which are shown in FIG. 2 uniformly and negatively charge surfaces of the image holding bodies 21 for the respective colors at a predetermined potential. Next, based on image data input from the outside, the exposure devices 23 irradiate the charged surfaces of the image holding bodies 21 for the respective colors with exposure light to form electrostatic latent images.

Accordingly, electrostatic latent images corresponding to the image data are formed on the respective surfaces of the image holding bodies 21. Furthermore, the development devices 24 for the respective colors develop the electrostatic latent images, and visualize the electrostatic latent images as toner images. In addition, the primary transfer rolls 33 of the transfer device 30 shown in FIG. 1 sequentially transfer, to the transfer belt 31, the toner images formed on the surfaces of the image holding bodies 21 for the respective colors at the primary transfer positions T.

Therefore, the sheet member P that is fed from the accommodation unit 50 to the supply path 40 by the feeding roll 58 is delivered to the leading end holding portion 68 (refer to FIG. 3) of the chain gripper 66 and is transported. The sheet member P transported by the chain gripper 66 is fed toward the secondary transfer position NT. At the secondary transfer position NT, the sheet member P is transported while being sandwiched between the transfer belt 31 and the transfer cylinder 36 and thus the toner images on a surface of the transfer belt 31 are transferred onto a surface of the sheet member P.

Furthermore, the fixing device 100 fixes, onto the sheet member P, the toner images transferred onto the surface of the sheet member P and the sheet member P transported by the chain gripper 66 is fed to the discharge path 42. The sheet member P fed to the discharge path 42 is discharged to the outside of the apparatus body 10a.

### Major Configuration

Next, the transfer device 30 will be described. The transfer device 30 is an example of a transfer system.

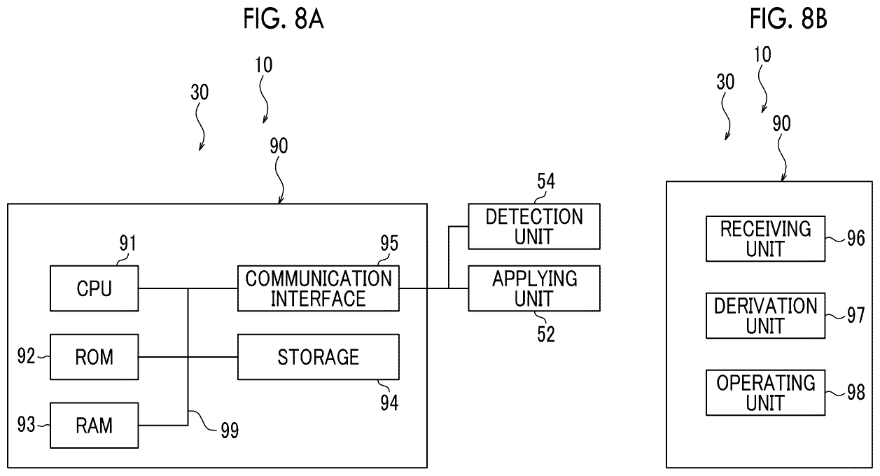

As shown in FIG. 1, the transfer device 30 includes the transfer belt 31, the plurality of rolls 32, the primary transfer rolls 33, the transfer cylinder 36, the scraping member 38, and a control unit 90 (refer to FIGS. 8A and 8B). The transfer device 30 is an example of a transfer system.

### Roll 32

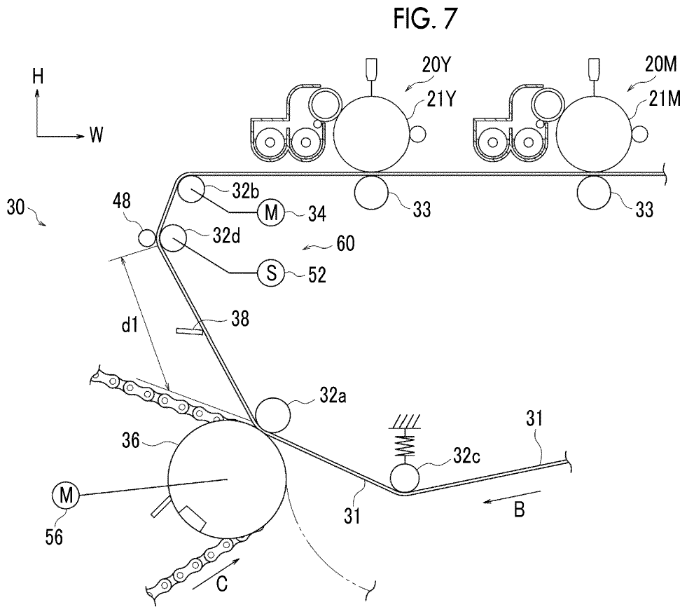

As shown in FIG. 7, the roll 32c that is disposed upstream of the roll 32a in the revolution direction of the transfer belt 31 functions as a tensile force applying roll that presses the transfer belt 31 from the inner surface of the transfer belt 31 and that applies a tensile force to the transfer belt 31. In addition, the roll 32b functions as a driving roll that is rotationally driven as a drive force from a drive source 34 is applied thereto. Furthermore, a detection unit 54 (refer to FIG. 8A) that detects torque acting on the roll 32b based on electric power applied to the drive source 34 is provided.

The roll 32d is disposed between the roll 32a and the roll 32b in the revolution direction of the transfer belt 31, presses the transfer belt 31 from the inner surface of the transfer belt 31 such that the transfer belt 31 is stretched outward, and rotates by being driven by the transfer belt 31 revolving. A shaft portion of the roll 32d is provided with an applying unit 52 which is a powder brake applying a braking force to the roll 32d and the roll 32d functions as a braking roll. The roll 32a is an example of a winding roll, the roll 32b is an example of a driving roll, and the roll 32d is an example of a braking roll.

In addition, the applying unit 52 and the roll 32d constitute a braking unit 60. Herein, in the present exemplary embodiment, the braking unit 60 is a member of which the major purpose is to apply a braking force to the transfer belt 31 by coming into contact with the inner surface of the transfer belt 31 and the braking unit 60 does not include the scraping member 38 which will be described later.

In addition, a sandwiching roll 48 that sandwiches the transfer belt 31 together with the roll 32d is provided on a side opposite to the roll 32d with the transfer belt 31 interposed therebetween. The sandwiching roll 48 is an example of a pinching roll.

### Transfer Cylinder 36

As shown in FIG. 7, the transfer cylinder 36 is disposed on a side opposite to the roll 32a with the transfer belt 31 interposed therebetween and rotates as a drive force of a drive source 56 is transmitted thereto.

### Scraping Member 38

As shown in FIG. 7, the scraping member 38 is disposed between the roll 32a and the roll 32d in the revolution direction of the transfer belt 31 and the scraping member 38 has a function of scraping an adhering substance adhering to a surface of the transfer belt 31 off the transfer belt 31.

### Control Unit 90

### Hardware Configuration of Control Unit 90

As shown in FIG. 8A, the control unit 90 includes a central processing unit (CPU) 91, a read only memory (ROM) 92, a random access memory (RAM) 93, a storage 94, and a communication interface (I/F) 95. In addition, the components are communicably connected to each other via a bus 99. The CPU 91 is an example of a processor.

The CPU 91 is a central processing unit and executes various programs or controls each unit. That is, the CPU 91 reads a program from the ROM 92 or the storage 94, and executes the program while using the RAM 93 as a work area. The CPU 91 controls each component and performs various calculation processes in accordance with a program stored in the ROM 92 or the storage 94.

In the present exemplary embodiment, for example, the ROM 92 or the storage 94 stores a braking program that controls, based on torque information detected by the detection unit 54, the applying unit 52 to change the braking force of the roll 32d.

The RAM 93 temporarily stores a program or data as a work area. The storage 94 is composed of a hard disk drive (HDD) or a solid state drive (SSD) and stores various programs including an operating system and various data.

The communication interface 95 is an interface that is used to communicate with the detection unit 54 or the like and for example, standards, such as ETHERNET (registered trademark), FDDI, and Wi-Fi (registered trademark), are used for the communication interface 95.

In a case where the above-described braking program is to be executed, the control unit 90 implements various functions by using hardware resources described above. Next, a functional configuration of the control unit 90 in which the control unit 90 realizes various functions will be described.

### Functional Configuration of Control Unit 90

As shown in FIG. 8B, the control unit 90 includes a receiving unit 96, a derivation unit 97, and an operating unit 98. Each functional configuration is realized as the CPU 91 reads and executes a driving program stored in the ROM 92 or the storage 94. Note that the details of the control unit 90 will be described together with the action which will be described later.

### Action of Major Configuration

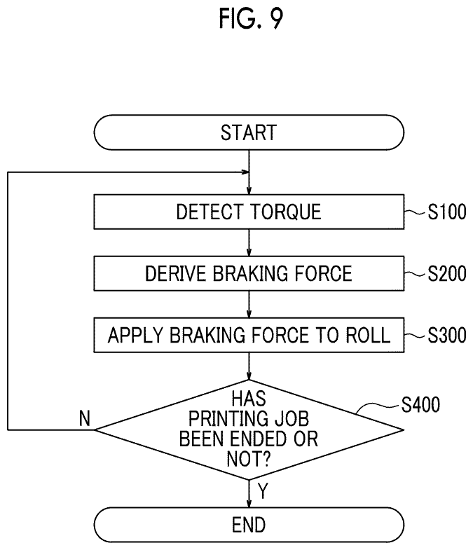

Next, the action of a major configuration will be described. Specifically, a step of controlling the revolution speed of the transfer belt 31 in a case where toner images formed by the toner image forming units 20 are transferred to the transfer belt 31 and the toner images transferred to the transfer belt 31 are transferred to the sheet member P will be described with reference to a flowchart shown in FIG. 9.

In a case where the receiving unit 96 of the control unit 90 receives an instruction to start a transfer operation, the operating unit 98 operates the drive source 34 such that the roll 32b rotates and the transfer belt 31 revolves. Furthermore, the operating unit 98 operates the drive source 56 such that the transfer cylinder 36 rotates and the chains 72 revolve. Then, in step S100, the receiving unit 96 of the control unit 90 detects, from the detection unit 54, torque acting on the roll 32b.

Furthermore, in step S200, the derivation unit 97 derives a braking force to be caused to act on the roll 32d. Specifically, the braking force to be caused to act on the roll 32d is derived such that torque acting on the roll 32b fluctuates with the fluctuating torque being equal to or less than a threshold value. In other words, the braking force to be caused to act on the roll 32d is derived such that a tensile force at a portion of the transfer belt 31 between the roll 32d and the roll 32b fluctuates with the fluctuating tensile force being equal to or less than a threshold value.

Then, in step S300, the operating unit 98 controls the applying unit 52 such that the braking force is applied to the roll 32d.

Furthermore, a series of operations ends in a case where the receiving unit 96 receives printing information and a printing job has ended in step S400. Meanwhile, in a case where the printing job is in progress, the process returns to step S100 described above and the series of operations is executed again.

As described above, a braking force is applied to the roll 32d such that the torque on the roll 32b is made equal to or less than the threshold value. In other words, the braking force is applied to the roll 32d such that the tensile force at a portion of the transfer belt 31 between the roll 32d and the roll 32b is made equal to or less than the threshold value.

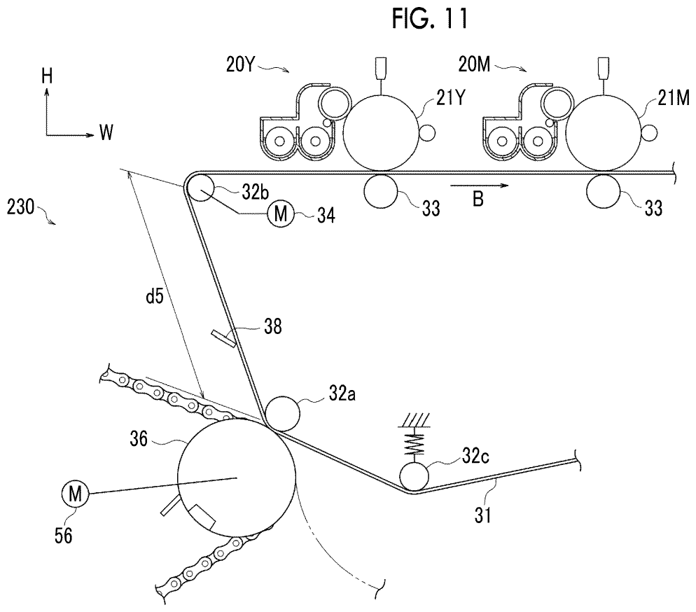

Here, an example of the reason why the torque acting on the roll 32b fluctuates and the reason why the torque acting on the roll 32b is made equal to or less than the threshold value will be described while comparing with a transfer device 230 according to a comparative exemplary embodiment. First, the configuration of the transfer device 230 according to the comparative exemplary embodiment will be described focusing on a portion of the transfer device 230 that is different from the transfer device 30 of the present exemplary embodiment. As shown in FIG. 11, the transfer device 230 is not provided with the roll 32d.

Regarding the example of the reason why the torque acting on the roll 32b fluctuates, the degree of an adhering substance adhering to a surface of the transfer belt 31 may partially differ in the revolution direction of the transfer belt 31. In this case, a frictional force generated between the transfer cylinder 36 rotationally driven and the transfer belt 31 fluctuates.

In the transfer device 230 according to the comparative exemplary embodiment shown in FIG. 11, a tensile force acting on a portion (a portion d5 shown in FIG. 11) of the transfer belt 31 between the roll 32a and the roll 32b in the revolution direction of the transfer belt 31 fluctuates due to the fluctuation in frictional force. Due to the fluctuation, the torque acting on the roll 32b also fluctuates. In a case where the roll 32b is rotationally driven in a state where the tensile force on a portion of the transfer belt 31 between the roll 32a and the roll 32b fluctuates, the revolution speed (the amount of transportation) of a portion of the transfer belt 31, onto which toner images are transferred from the image holding bodies 21, fluctuates. In addition, in a case where the revolution speed of the transfer belt 31 fluctuates, images to be transferred to the transfer belt 31 from the image holding bodies 21 for the respective colors deviate. So-called image deviation occurs.

Meanwhile, in the transfer device 30 of the present exemplary embodiment shown in FIG. 7, the torque acting on the roll 32b is made equal to or less than the threshold value so that a tensile force fluctuates only at a portion (a portion d1 in FIG. 7) of the transfer belt 31 between the roll 32a and the roll 32d. In this case, a fluctuation in tensile force is suppressed at a portion of the transfer belt 31 that is positioned downstream of the roll 32d in the revolution direction of the transfer belt 31 and thus a fluctuation in revolution speed (amount of transportation) of a portion of the transfer belt 31, onto which toner images are transferred from the image holding bodies 21, is also suppressed. In addition, in a case where a fluctuation in revolution speed of the transfer belt 31 is suppressed, image deviation of images transferred to the transfer belt 31 from the image holding bodies 21 for the respective colors is suppressed.

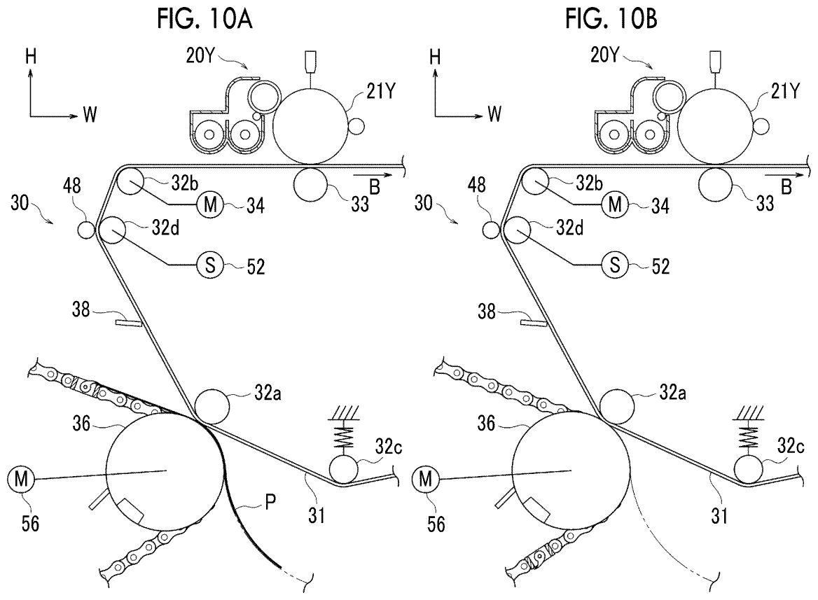

Note that a frictional force generated between the transfer cylinder 36 rotationally driven and the transfer belt 31 fluctuates between when the sheet member P is sandwiched between the transfer cylinder 36 and the transfer belt 31 and when the sheet member P is not sandwiched between the transfer cylinder 36 and the transfer belt 31 as shown in FIGS. 10A and 10B, for example. Furthermore, a fluctuation in frictional force may occur depending on the density of toner images formed on the sheet member P.

### Summary

As described above, in the transfer device 30, the roll 32d that is disposed downstream of the roll 32a in the revolution direction of the transfer belt 31 and that is disposed upstream of the roll 32b applies a braking force to the transfer belt 31 revolving. Accordingly, image deviation of images transferred to the transfer belt 31 from the toner image forming units 20 for the respective colors is suppressed in comparison with a case where an inner surface of a portion of the transfer belt 31 that is positioned downstream of the roll 32a in the revolution direction of the transfer belt 31 and that is positioned upstream of the roll 32b is free.

In addition, in the transfer device 30, a braking force is applied to the roll 32d that rotates by being driven by the transfer belt 31 revolving. Therefore, wear of the transfer belt is suppressed in comparison with a case where a braking unit that is not rotatable is used.

In addition, in the transfer device 30, the sandwiching roll 48 that sandwiches the transfer belt 31 together with the roll 32d is disposed on a side opposite to the roll 32d with the transfer belt 31 interposed therebetween. Therefore, the braking force of the roll 32d is effectively transmitted to the transfer belt 31 in comparison with a case where a transfer belt is loose with respect to a braking roll.

In addition, in the transfer device 30, the sandwiching roll 48 that sandwiches the transfer belt 31 together with the roll 32d is disposed on a side opposite to the roll 32d with the transfer belt 31 interposed therebetween. Therefore, wear of the transfer belt 31 is suppressed in comparison with a case where a sandwiching member that is not rotatable is used.

In addition, in the transfer device 30, the control unit 90 controls, based on torque detected by the detection unit 54, the applying unit 52 such that torque acting on the roll 32d is made equal to or less than a threshold value. Therefore, the applying unit 52 is controlled with a simple configuration in comparison with a case where a tensile force acting on a transfer belt is detected to control a braking unit.

In addition, in the transfer device 30, the control unit 90 controls, based on torque detected by the detection unit 54, the applying unit 52 such that torque acting on the roll 32d is made equal to or less than a threshold value. Therefore, the torque acting on the roll 32d is easily made equal to or less than the threshold value in comparison with a case where a braking member that is not rotatable is used.

In addition, in the transfer device 30, the scraping member 38 that scrapes off an adhering substance adhering to the transfer belt 31 is provided downstream of the roll 32a in the revolution direction of the transfer belt 31 and upstream of the roll 32d. Accordingly, image deviation of images transferred to the transfer belt 31 from the toner image forming units 20 for the respective colors is suppressed in comparison with a case where a fluctuation in tensile force on a transfer belt that is caused by a frictional force between a scraping member and the transfer belt is directly transmitted to a portion of the transfer belt onto which an image is transferred and thus the revolution speed of the transfer belt fluctuates.

In addition, in the image forming apparatus 10, since the transfer device 30 is provided, a decrease in quality of output images is suppressed in comparison with a case where the transfer device 230 according to the comparative exemplary embodiment is provided.

Although the specific exemplary embodiment of the present disclosure has been described in detail, the present disclosure is not limited to such an exemplary embodiment, and it is apparent to those skilled in the art that various other exemplary embodiments can be adopted within the scope of the present disclosure. For example, in the above-described exemplary embodiment, a braking force is applied to the transfer belt 31 via the roll 32d that rotates. However, a braking force may be applied to the transfer belt 31 via a braking member that is not rotatable. In this case, an effect achieved in a case where the roll 32d is used cannot be achieved.

In addition, in the above-described exemplary embodiment, the sandwiching roll 48 is used so that the transfer belt 31 is sandwiched between the sandwiching roll 48 and the roll 32d. However, the sandwiching roll 48 may not be used. In this case, an effect achieved in a case where the sandwiching roll 48 is used cannot be achieved.

In addition, in the above-described exemplary embodiment, the control unit 90 controls, based on torque detected by the detection unit 54, the applying unit 52 such that torque acting on the roll 32b is made equal to or less than the threshold value. However, a braking unit may be controlled based on a braking condition stored in advance. However, in this case, an effect achieved in a case where the applying unit 52 is controlled based on torque detected by the detection unit 54 cannot be achieved.

(((1)))

A transfer system comprising:
a transfer belt that has an endless shape and onto which images held by a plurality of image holding bodies are sequentially transferred;
a winding roll around which the transfer belt is wound and that rotates by being driven by the transfer belt revolving;
a driving roll around which the transfer belt is wound, that is disposed downstream of the winding roll in a revolution direction of the transfer belt and upstream of a portion of the transfer belt onto which the image is transferred, and that applies a drive force to the transfer belt to cause the transfer belt to revolve;
a transfer cylinder that is disposed on a side opposite to the winding roll with the transfer belt interposed therebetween and that transfers, to a recording medium transported, the image on the transfer belt while being rotationally driven; and
a braking unit that is disposed downstream of the winding roll in the revolution direction of the transfer belt and upstream of the driving roll and that comes into contact with an inner surface of the transfer belt revolving so that a braking force is applied to the transfer belt.
   (((2)))

The transfer system according to (((1))),
wherein the braking unit includes a braking roll around which the transfer belt is wound and that rotates by being driven by the transfer belt revolving and an applying unit that applies a braking force to the braking roll.
   (((3)))

The transfer system according to (((1))), further comprising:
a pinching member that is disposed on a side opposite to a braking roll with the transfer belt interposed therebetween.
   (((4)))

The transfer system according to (((3))),
wherein the pinching member is a pinching roll that rotates by being driven by the transfer belt.
   (((5)))

The transfer system according to any one of (((1))) to (((4))), further comprising:
a detection unit that detects torque acting on the driving roll; and
at least one processor,
wherein the processor is configured to:
   control, based on a result of detection performed by the detection unit, the braking unit such that the torque acting on the driving roll is made equal to or less than a threshold value.
      (((6)))

The transfer system according to (((4))),
wherein the braking unit includes a braking roll around which the transfer belt is wound and an applying unit that applies a braking force to the braking roll, and
the processor is configured to:
   control the applying unit.
      (((7)))

The transfer system according to any one of (((1))) to (((6))),
wherein a scraping member that scrapes off an adhering substance adhering to the transfer belt is disposed downstream of the winding roll in the revolution direction of the transfer belt and upstream of the braking unit.
   (((8)))

An image forming system comprising:
the transfer system according to any one of (((1))) to (((7))); and
a fixing device that fixes, onto the recording medium, an image transferred to the recording medium.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transfer system comprising:
a transfer belt that has an endless shape and onto which images held by a plurality of image holding bodies are sequentially transferred;
a winding roll around which the transfer belt is wound and that rotates by being driven by the transfer belt revolving;
a driving roll around which the transfer belt is wound, that is disposed downstream of the winding roll in a revolution direction of the transfer belt and upstream of a portion of the transfer belt onto which the image is transferred, and that applies a drive force to the transfer belt to cause the transfer belt to revolve;
a transfer cylinder that is disposed on a side opposite to the winding roll with the transfer belt interposed therebetween and that transfers, to a recording medium transported, the image on the transfer belt while being rotationally driven; and
a braking unit that is disposed downstream of the winding roll in the revolution direction of the transfer belt and upstream of the driving roll and that comes into contact with an inner surface of the transfer belt revolving so that a braking force is applied to the transfer belt.

2. The transfer system according to claim 1,
wherein the braking unit includes a braking roll around which the transfer belt is wound and that rotates by being driven by the transfer belt revolving and an applying unit that applies a braking force to the braking roll.

3. The transfer system according to claim 2, further comprising:
a pinching member that is disposed on a side opposite to a braking roll with the transfer belt interposed therebetween.

4. The transfer system according to claim 3,
wherein the pinching member is a pinching roll that rotates by being driven by the transfer belt.

5. The transfer system according to claim 1, further comprising:
a detection unit that detects torque acting on the driving roll; and
at least one processor,
wherein the processor is configured to:
control, based on a result of detection performed by the detection unit, the braking unit such that the torque acting on the driving roll is made equal to or less than a threshold value.

6. The transfer system according to claim 5,
wherein the braking unit includes a braking roll around which the transfer belt is wound and an applying unit that applies a braking force to the braking roll, and
the processor is configured to:
control the applying unit.

7. The transfer system according to claim 1,
wherein a scraping member that scrapes off an adhering substance adhering to the transfer belt is disposed downstream of the winding roll in the revolution direction of the transfer belt and upstream of the braking unit.

8. An image forming system comprising:
the transfer system according to claim 1; and
a fixing device that fixes, onto the recording medium, an image transferred to the recording medium.

9. An image forming system comprising:
the transfer system according to claim 2; and
a fixing device that fixes, onto the recording medium, an image transferred to the recording medium.

10. An image forming system comprising:
the transfer system according to claim 3; and
a fixing device that fixes, onto the recording medium, an image transferred to the recording medium.

11. An image forming system comprising:
the transfer system according to claim 4; and
a fixing device that fixes, onto the recording medium, an image transferred to the recording medium.

12. An image forming system comprising:
the transfer system according to claim 5; and
a fixing device that fixes, onto the recording medium, an image transferred to the recording medium.

13. An image forming system comprising:
the transfer system according to claim 6; and
a fixing device that fixes, onto the recording medium, an image transferred to the recording medium.

14. An image forming system comprising:
the transfer system according to claim 7; and
a fixing device that fixes, onto the recording medium, an image transferred to the recording medium.

15. A transfer system comprising:
a transfer belt that has an endless shape and onto which images held by a plurality of image holding bodies are sequentially transferred;
a winding roll around which the transfer belt is wound and that rotates by being driven by the transfer belt revolving;
a driving roll around which the transfer belt is wound, that is disposed downstream of the winding roll in a revolution direction of the transfer belt and upstream of a portion of the transfer belt onto which the image is transferred, and that applies a drive force to the transfer belt to cause the transfer belt to revolve;
a transfer cylinder that is disposed on a side opposite to the winding roll with the transfer belt interposed therebetween and that transfers, to a recording medium transported, the image on the transfer belt while being rotationally driven; and
a braking unit that is disposed downstream of the winding roll in the revolution direction of the transfer belt and upstream of the driving roll and that comes into contact with an inner surface of the transfer belt revolving so that a braking force is applied to the transfer belt.
